(19) United States
(12) Patent Application Publication
(10) Pub. No.: US 2025/0298287 A1
(43) Pub. Date: Sep. 25, 2025

(54) CAMERA MODULE AND CAMERA ACTUATOR

(71) Applicant: SAMSUNG ELECTRO-MECHANICS CO., LTD., Suwon-si (KR)

(72) Inventors: Chueljin PARK, Suwon-si (KR); Dooseub SHIN, Suwon-si (KR); Donghoon LEE, Suwon-si (KR); Sanghyun JI, Suwon-si (KR)

(73) Assignee: SAMSUNG ELECTRO-MECHANICS CO., LTD., Suwon-si (KR)

(21) Appl. No.: 19/008,120

(22) Filed: Jan. 2, 2025

(30) Foreign Application Priority Data
Mar. 20, 2024 (KR) 10-2024-0038562

(51) Int. Cl. G03B 5/00; G03B 13/36; G03B 30/00

(52) U.S. Cl. CPC G03B 5/00; G03B 13/36; G03B 30/00; G03B 2205/0046; G03B 2205/0061; G03B 2205/0069

(57) ABSTRACT

A camera module includes a housing having an internal space; a lens module accommodated in the internal space of the housing and including a first lens barrel; and a camera actuator, connected to the first lens barrel, configured to provide a driving force, wherein the camera actuator includes a first movable unit configured to move the first lens barrel in a first direction, a first driver including a first piezoelectric element, connected to the first movable unit, and configured to provide a driving force to the first movable unit, and a magnet and a yoke disposed between the first movable unit and the housing in a second direction intersecting with the first direction.

### CROSS-REFERENCE TO RELATED APPLICATIONS

This application claims the benefit under 35 USC 119(a) of Korean Patent Application No. 10-2024-0038562 filed on Mar. 20, 2024, in the Korean Intellectual Property Office, the entire disclosure of which is incorporated herein by reference for all purposes.

### BACKGROUND

### 1. Field

The following description disclosure relates to a camera module and a camera actuator.

### 2. Description of the Background

A folded camera module may include a reflectometer that reflects outside light at 90 degrees and an optical system that passes light refracted by the reflectometer in a mobile device's width or length direction. Such a folded camera module may have adequate distance between the lenses to implement a high-magnification optical zoom function while maintaining a slim profile.

Unlike a method of the related art in which a sensor (an imaging device such as a CCD, a CMOS, and the like) and lenses are vertically stacked, the folded camera module adopts a periscope structure, making it possible to achieve the high-magnification optical zoom function without increasing an overall height. In addition, since the periscope structure is different from the method of the related art in which the lenses are vertically stacked, the folded camera module is advantageous in realizing a module's slimness compared to the related art method.

As key factors that decisively affect the zoom performance of a camera, not only specifications of lenses constituting an optical system but also a driving range of the optical system is included. As the driving range of the optical system increases, an improved zoom performance may be realized. In a small camera mounted with a zoom lens, a voice coil motor-type driving mechanism may be mainly used to increase an optical system's driving range.

However, the voice coil motor-type driving mechanism applied as an optical system driving device to the folded camera module in the related art is disadvantageous in terms of miniaturization of a device. Accordingly, a piezo-type driving mechanism using a piezoelectric element is recently in the spotlight as an alternative to the related art's voice coil motor-type driving mechanism. In the piezo-type driving mechanism, contraction and expansion are generated when a high-frequency pulse voltage is applied to the piezoelectric element, which drives an optical system.

In such a piezo-type driving device, it is desirable to maintain contact force between a driver, including the piezoelectric element, and a movable unit.

The above information is presented as background information only to assist with an understanding of the present disclosure. No determination has been made, and no assertion is made, as to whether any of the above might be applicable as prior art with regard to the disclosure.

### SUMMARY

An aspect of the present disclosure can provide a camera module and actuator that can be miniaturized and resist impact.

In one general aspect, a camera module includes a housing having an internal space; a lens module accommodated in the internal space of the housing and including a first lens barrel; and a camera actuator connected to the first lens barrel and configured to provide a driving force, wherein the camera actuator includes a first movable unit configured to move the first lens barrel in a first direction, a first driver including a first piezoelectric element, connected to the first movable unit, and configured to provide a driving force to the first movable unit, and a magnet and a yoke disposed between the first movable unit and the housing in a second direction intersecting with the first direction.

The magnet may be disposed on one surface of the first movable unit facing the housing, and the yoke may be disposed to face the magnet in the second direction.

The yoke may extend in the first direction to include a portion overlapping the magnet in the second direction.

The camera actuator may further include a second movable unit disposed to face the first movable unit with the first lens barrel interposed therebetween, in a third direction perpendicular to the first direction and the second direction, and at least one first rolling member disposed on one side of the second movable unit, and the second movable unit may be configured to move the first lens barrel in the first direction using the driving force of the first driver.

The magnet may include a first magnet disposed on one surface of the first movable unit, and a second magnet disposed on one surface of the second movable unit, and the first magnet may be larger in size than the second magnet.

The first rolling member may be a single ball.

The first driver may further include a rod disposed such that one end is connected to the first piezoelectric element and another end is connected to the first movable unit, and the first magnet and the second magnet may be disposed between the rod and the first rolling member along the third direction.

The first driver may further include a rod disposed such that one end is connected to the first piezoelectric element and another end is connected to the first movable unit, and a friction part configured to have higher wear resistance than the first movable unit and disposed on one surface of the first movable unit facing the rod.

The lens module may further include a second lens barrel disposed on one side in the first direction of the first lens barrel and configured to be movable with respect to the housing, and a third lens barrel disposed on another side in the first direction of the first lens barrel and fixed to the housing.

The camera actuator may further include a third movable unit disposed on one side of the second lens barrel and configured to move the second lens barrel in the first direction, a fourth movable unit disposed to face the third movable unit with the second lens barrel interposed therebetween, in a third direction perpendicular to the first direction and the second direction, and a second driver including a second piezoelectric element, connected to the third movable unit, and configured to provide a driving force to the third movable unit.

The camera module may further include at least one second rolling member disposed on one side of the fourth movable unit.

The second driver may be disposed diagonally from the first driver with respect to a reference line parallel to the first direction.

The camera module may further include a reflection module disposed in front of the first lens barrel in the first direction and configured to change a path of incident light.

In another general aspect, a camera actuator includes a first movable unit configured to move along a first direction; a driver including a piezoelectric element, connected to the first movable unit, and configured to provide a driving force to the first movable unit; a yoke disposed on one side of the first movable unit in a second direction intersecting with the first direction; and a camera actuator including a magnet disposed between the first movable unit and the yoke in the second direction.

The yoke may be disposed to face the magnet in the second direction.

The yoke may extend in the first direction to include a portion overlapping the magnet in the second direction.

The driver may be disposed on one side in the second direction of the first movable unit, the camera actuator may further include a second movable unit disposed to face the first movable unit in a third direction perpendicular to the first direction and the second direction, and at least one rolling member disposed on one side of the second movable unit.

The magnet may include a first magnet disposed on one surface of the first movable unit, and a second magnet disposed on one surface of the second movable unit, and the first magnet may be larger in size than the second magnet.

The driver may further include a rod disposed such that one end is connected to the piezoelectric element and another end is connected to the first movable unit, and the first magnet and the second magnet may be disposed between the rod and the first rolling member in the third direction perpendicular to the first direction and the second direction.

The driver may further include a friction part configured to have higher wear resistance than the first movable unit and disposed on one surface of the first movable unit facing the rod.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF DRAWINGS

FIG. 1 is a perspective view of a camera module according to an embodiment.

FIG. 2 is an exploded perspective view of the camera module according to an embodiment.

FIG. 3 is an exploded perspective view of a camera actuator shown in FIG. 2.

FIG. 4 is a plan view of a configuration of a part of the camera module shown in FIG. 1.

FIG. 5 is a perspective view of a movable unit and a driver according to an embodiment.

FIG. 6 is a plan view of a camera actuator according to an embodiment.

FIG. 7 is a cross-sectional view taken along line VII-VII′ of a lens module shown in FIG. 6.

FIG. 8 is a cross-sectional view taken along line VIII-VIII′ of the lens module shown in FIG. 6.

FIG. 9 is a plan view of a camera actuator according to another embodiment.

FIG. 10 is a perspective view of a movable unit and a driver according to still another embodiment.

FIG. 11 is a perspective view of a movable unit and a driver according to a variation of a camera module according to still another embodiment.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

For reference, in the three-axis direction coordinate system, a Z-axis may refer to a direction in which light passes through a lens, that is, an optical axis direction, an X-axis may refer to a direction perpendicular to the Z-axis, and a Y-axis may refer to a direction perpendicular to the Z-axis and the X-axis.

Hereinafter, a configuration in which two pairs of movable units are arranged to be spaced apart in the Z-axis direction in one camera actuator and a driver is arranged to correspond to each of the two pairs of movable units will be described as an example. This is only one of the embodiments for describing the invention, and the numbers of the movable units and the drivers are not limited to the illustrative form in the drawings.

One or more embodiments of the present disclosure can provide a camera module and actuator that can be miniaturized and resist impact.

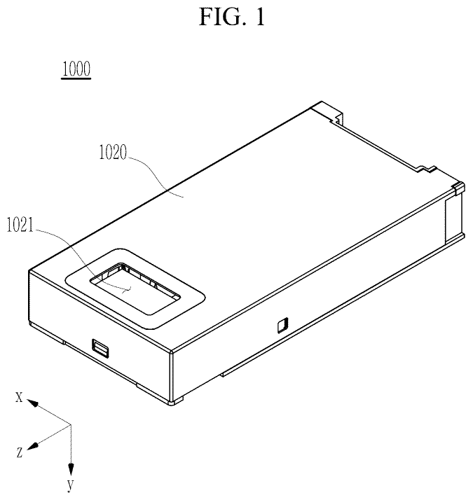

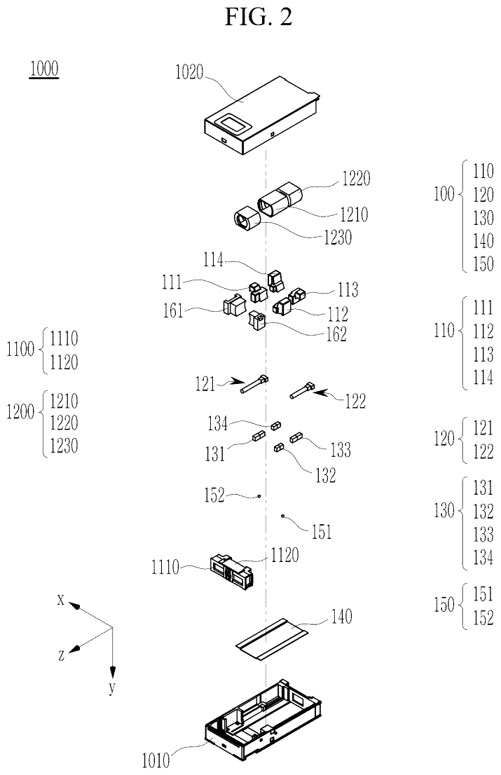

FIG. 1 is a perspective view of a camera module according to an embodiment, and FIG. 2 is an exploded perspective view of the camera module according to an embodiment.

Referring to FIGS. 1 and 2, a camera module 1000, according to an embodiment, may include a reflection module 1100, a lens module 1200, a camera actuator 100, and an image sensor module (not shown) provided in a housing 1010 having an internal space.

The camera module 1000, according to an embodiment, may include a cover 1020 covering the housing 1010 from the top in the Y-axis direction. The reflection module 1100 may be configured to change the traveling direction of light. As an example, light may be incident through an opening portion 1021 of the cover 1020, and the traveling direction of the incident light may be changed to be directed toward the lens module 1200 by the reflection module 1100.

The reflection module 1100 may include a rotation holder 1110 supported toward the housing 1010, an optical path-changing member 1120 mounted on the rotation holder 1110, and a reflection driver (not shown) that moves the rotation holder 1110.

The optical path-changing member 1120 may change a light path (for example, reflect light). The optical path-changing member 1120 may include a mirror, a prism, a beam splitter, and the like. A path of light incident on the camera module 1000 in the Y-axis direction may be changed by the reflection module 1100 so as to approximately match an optical axis direction (Z-axis direction). Then, the light of which the path is changed may be incident on the lens module 1200.

The reflection module 1100 may include the rotation holder 1110. The housing 1010 and the rotation holder 1110 facing the housing may be provided with a first magnetic body (not shown) and a second magnetic body (not shown) on facing surfaces thereof, respectively. The rotation holder 1110 may be in close contact with the housing 1010 by an attractive force between the first magnetic body and the second magnetic body.

Here, the first magnetic body and the second magnetic body may be a pulling yoke and a pulling magnet. For example, the first magnetic body and the second magnetic body may be selectively a pulling yoke and a pulling magnet, or both the first magnetic body and the second magnetic body may be pulling magnets.

Here, the first magnetic body and the second magnetic body may be a pulling yoke and a pulling magnet. For example, the first magnetic body and the second magnetic body may be selectively a pulling yoke and a pulling magnet, or both the first magnetic body and the second magnetic body may be pulling magnets. As an example, the reflection driver may include a plurality of magnets and a plurality of coils arranged to face the plurality of magnets.

The lens module 1200 may be accommodated in the internal space of the housing 1010. The lens module 1200 may include at least one lens barrel. The camera actuator 100 may be connected to lens barrels 1210, 1220, and 1230 to provide a driving force to the lens barrels 1210, 1220, and 1230.

Each of the at least one lens barrel 1210, 1220, and 1230 may include at least one lens through which light of which the traveling direction is changed by the reflection module 1100 passes. In an embodiment, three lens barrels are provided. However, there may be one or more lens barrels.

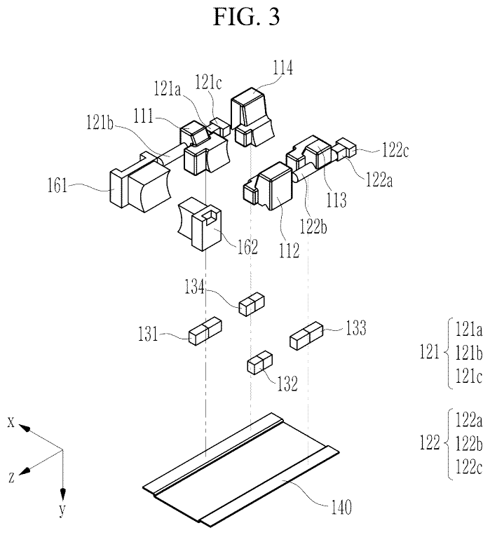

The camera actuator 100 may include at least one movable unit 110 configured to move the lens barrel in the Z-axis direction, at least one driver 120 connected to the movable unit 110 and configured to provide a driving force to the movable unit 110, a magnet 130 arranged between the movable unit 110 and the housing 1010 along the Y-axis direction, and a yoke 140 arranged between the movable unit 110 and the housing 1010 in the Y-axis direction. Additionally, the camera actuator 100 may include at least one rolling member 150 arranged between at least one movable unit 110 and the housing 1010. Referring to FIG. 3 below, the driver 120 may include piezoelectric elements 121a and 122a.

Movement of at least one of the plurality of lens barrels in the optical axis direction (Z-axis direction) can implement autofocus (AF) and/or zoom functions. As an example, the plurality of lens barrels may include first to third lens barrels 1210, 1220, and 1230. In an embodiment, all three lens barrels 1210, 1220, and 1230 may move in the optical axis direction, or one of them may be fixed so as not to move in the optical axis direction. For example, autofocus (AF) and zoom functions may be implemented by the first and second lens barrels 1210 and 1220, which are movable lens barrels.

The driver 120 may include a first driver 121 and a second driver 122. Referring to FIG. 3 below, the first driver 121 may include a first piezoelectric element 121a and a first rod 121b located on one side of the first piezoelectric element 121a. Referring to FIG. 3 below, the second driver 122 may include a second piezoelectric element 122a and a second rod 122b located on one side of the second piezoelectric element 122a. The first rod 121b may move linearly according to the contraction and expansion of the first piezoelectric element 121a. The second rod 122b may move linearly according to the contraction and expansion of the second piezoelectric element 122a. At least one movable unit 110 may be connected to the first rod 121b or the second rod 122b to receive a driving force.

The first to third lens barrels 1210, 1220, and 1230 may be arranged on a bottom surface of the housing 1010. For example, the first lens barrel 1210 may be supported on the bottom surface of the housing 1010 via at least one first rolling member 151 and the first rod 121b. The second lens barrel 1220 may be supported on the bottom surface of the housing 1010 via at least one second rolling member 152 and the second rod 122b.

The image sensor module may include an image sensor (not shown) that converts light passing through a lens into an electrical signal and a printed circuit board (not shown) on which the image sensor is mounted. Additionally, the image sensor module may include an optical filter (not shown) that filters light incident through the lens module 1200. The optical filter may be an infrared cutoff filter.

In the internal space of the housing 1010, the reflection module 1100 may be provided in front of the lens module 1200 in the Z-axis direction, and the image sensor module may be provided behind the lens module 1200 in the Z-axis direction. The reflection module 1100, the lens module 1200, and the image sensor module may be sequentially arranged from one side toward the other side in the housing 1010 in the Z-axis direction.

The camera module 1000 of an embodiment may include a structure in which the reflection module 1100, the lens module 1200, and the image sensor module are provided in the housing 1010. However, even if not shown in the drawings, structures in which a reflection module, a lens module, and the like are further provided in addition to the structure shown in the drawings may also be included.

The housing 1010 may be covered by the cover 1020 so that light is cut off and the internal space is not visible. The cover 1020 has the opening portion 1021 through which light is incident, and light incident through the opening portion 1021 changes its traveling direction by the reflection module 1100 and is incident on the lens module 1200. The cover 1020 may be provided integrally to cover the entire housing 1010, or may be provided as separate members to cover the reflection module 1100 and the lens module 1200, respectively.

In an embodiment, the housing 1010 may be an integrated structure or may have a structure including a plurality of housings that are distinct for each module. In describing each configuration in detail below, the description is based on the structure in which the housing 1010 is integrated, and even if there is no separate description that the housing is a separated structure, even all structures in which the housing is separated are included in the scope of the disclosure.

In the housing 1010, a space where the lens module 1200 is provided and a space where the reflection module 1100 is provided can be separated from each other by a protruding wall. The protruding wall may be provided in a shape that protrudes on both sides from the side wall of the housing 1010 into the internal space. The housing 1010 may include a connection terminal connecting the camera actuator 100 and a controller. The connection terminal may be inserted inside the housing 1010. The controller may include an integrated circuit.

Below, with reference to FIGS. 3 to 8, the camera actuator 100, according to an embodiment, will be described in more detail.

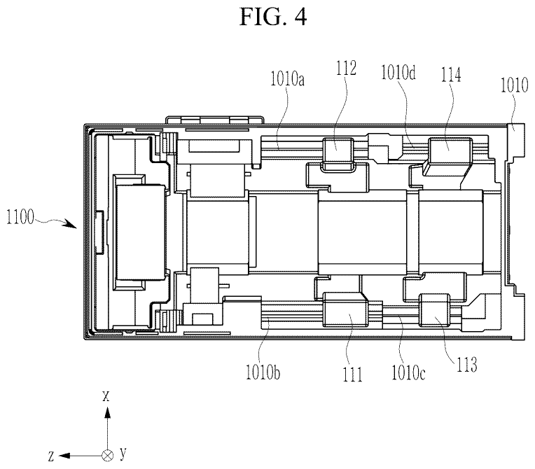

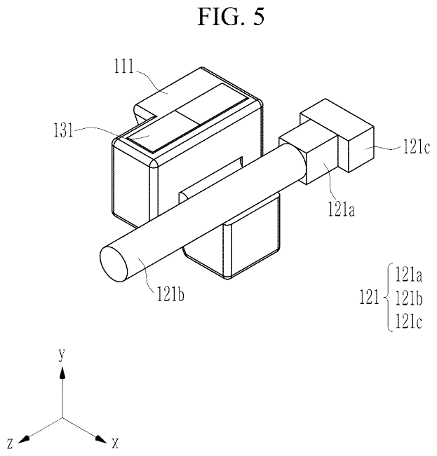

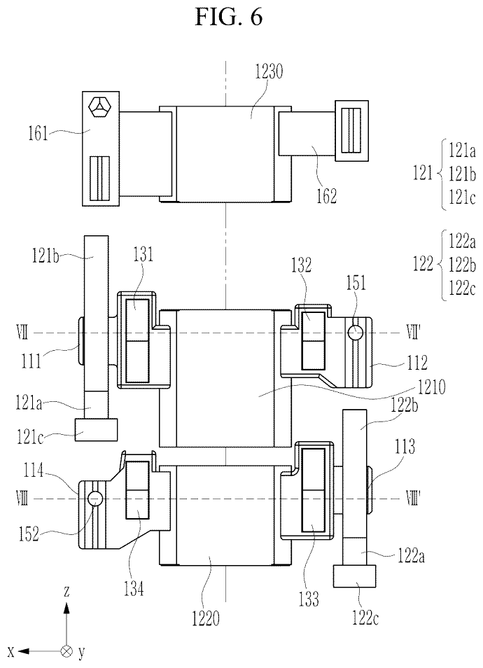

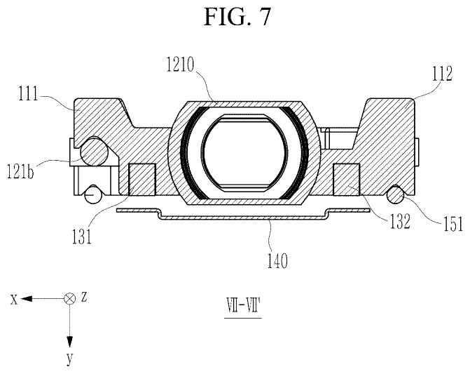

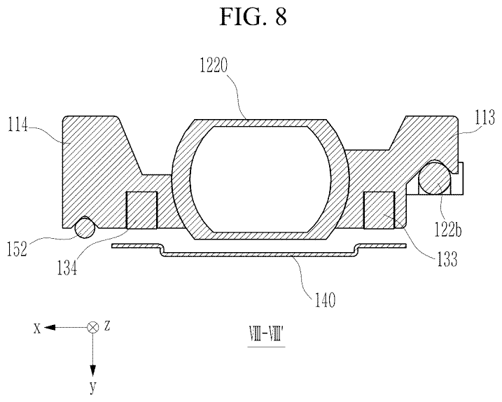

FIG. 3 is an exploded perspective view of a camera actuator shown in FIG. 2. FIG. 4 is a plan view of a configuration of a part of the camera module shown in FIG. 1. FIG. 5 is a perspective view of a movable unit and a driver according to an embodiment. FIG. 6 is a plan view of a camera actuator according to an embodiment. FIG. 7 is a cross-sectional view taken along line VII-VII′ of a lens module shown in FIG. 6. FIG. 8 is a cross-sectional view taken along line VIII-VIII′ of the lens module shown in FIG. 6.

Referring to FIGS. 3 to 6, the camera actuator 100, according to an embodiment, may include at least one movable unit 110. As an example, the camera actuator 100, according to an embodiment, may include first to fourth movable units 111, 112, 113, and 114. The movable unit 110 is configured to move the lens barrel 1220 and may be referred to as a carrier, a mover, a lens holder, or the like, for example.

The first movable unit 111 may be configured to move along the Z-axis direction. As an example, the first movable unit 111 may move along the Z-axis direction by receiving a driving force from the first driver 121 described below. The first movable unit 111 may be located on one side in the X-axis direction of the first lens barrel 1210.

The second movable unit 112 may be located on the other side in the X-axis direction of the first lens barrel 1210. The second movable unit 112 may be arranged to face the first movable unit 111 in the X-axis direction with the first lens barrel 1210 interposed therebetween. The second movable unit 112 may be connected to the first lens barrel 1210 and the first movable unit 111, and thus can receive a driving force from the first driver 121. The second movable unit 112 may be configured to move the first lens barrel 1210 in the Z-axis direction using the driving force of the first driver 121.

The third movable unit 113 may be configured to move along the Z-axis direction. As an example, the third movable unit 113 may move along the Z-axis direction by receiving a driving force from the second driver 122 described below. The third movable unit 113 may be located on one side in the X-axis direction of the second lens barrel 1220. The third movable unit 113 may be arranged on one side of the second lens barrel 1220 and configured to move the second lens barrel 1220 in the Z-axis direction.

The fourth movable unit 114 may be located on the other side in the X-axis direction of the second lens barrel 1220. The fourth movable unit 114 may be arranged to face the third movable unit 113 in the X-axis direction with the second lens barrel 1220 interposed therebetween. The fourth movable unit 114 may be connected to the second lens barrel 1220 and the third movable unit 113, and thus can receive a driving force from the second driver 122. The fourth movable unit 114 may be configured to move the second lens barrel 1220 in the Z-axis direction using the driving force of the second driver 122.

The first magnet 131 may be located on one surface of the first movable unit 111 facing the housing 1010 in the Y-axis direction. The first magnet 131 may be arranged on one surface in the Y-axis direction of the first movable unit 111. The second magnet 132 may be located on one surface of the second movable unit 112 facing the housing 1010 in the Y-axis direction. The second magnet 132 may be arranged on one surface in the Y-axis direction of the second movable unit 112. The first magnet 131 may be larger in size than the second magnet 132. As an example, the first magnet 131 may be larger in length in the Z-axis direction than the second magnet 132. As another example, the first magnet 131 may be larger in length in the Y-axis direction than the second magnet 132. In this case, the first rolling member 151 may be provided in the singular. The second rolling member 152 may be provided in the singular.

The first lens barrel 1210 may need to move a long distance in the optical axis direction in order to implement a zoom camera function. Accordingly, the first magnet 131 and the second magnet 132 may be magnetized with at least two poles in order to sequentially have N and S poles in the optical axis direction, respectively.

The third magnet 133 may be located on one surface of the third movable unit 113 facing the housing 1010 in the Y-axis direction. The third magnet 133 may be arranged on one surface in the Y-axis direction of the second movable unit 112. The fourth magnet 134 may be located on one surface of the fourth movable unit 114 facing the housing 1010 in the Y-axis direction. The fourth magnet 134 may be arranged on one surface in the Y-axis direction of the fourth movable unit 114. The third magnet 133 may be larger in size than the fourth magnet 134. As an example, the third magnet 133 may be larger in length in the Z-axis direction than the fourth magnet 134. As another example, the third magnet 133 may be larger in length in the Y-axis direction than the fourth magnet 134.

The second lens barrel 1220 may need to move a long distance in the optical axis direction in order to implement a zoom camera function. Accordingly, the third magnet 133 and the fourth magnet 134 may be magnetized with at least two poles in order to sequentially have N and S poles in the optical axis direction, respectively.

The first lens barrel 1210 may be fixed to the first movable unit 111 and provided in the housing 1010 to be movable in the optical axis direction (Z-axis direction). The first lens barrel 1210 may be fixed to the second movable unit 112 and provided in the housing 1010 to be movable in the optical axis direction (Z-axis direction).

The second lens barrel 1220 may be arranged on one side in the Z-axis direction of the first lens barrel 1210. The second lens barrels 1220 may be configured to be movable with respect to the housing 1010. The second lens barrel 1220 may be fixed to the third movable unit 113 and provided in the housing 1010 to be movable in the optical axis direction (Z-axis direction). The second lens barrel 1220 may be fixed to the fourth movable unit 114 and provided in the housing 1010 to be movable in the optical axis direction (Z-axis direction).

The third lens barrel 1230 may be arranged on the other side in the Z-axis direction of the first lens barrel 1210. The third lens barrels 1230 may be fixed to the housing 1010. The third lens barrel 1230 may be fixed to the first fixing holder 161 and the second fixing holder 162 and provided in the housing 1010.

The camera actuator 100, according to an embodiment, may include at least one driver 120. As an example, the camera actuator 100, according to an embodiment, may include first to fourth movable units 111, 112, 113, and 114.

The first driver 121 may be arranged on one side in the Y-axis direction of the first movable unit 111. The first driver 121 may be connected to the first movable unit 111 and configured to provide a driving force to the first movable unit 111. The first driver 121 may be located on one side in the X-axis direction of the first magnet 131.

Referring to FIGS. 3 to 6, the first driver 121 may include a first piezoelectric element 121a, a first rod 121b, and a first fixing member 121c. The first driver 121 may be a piezo actuator. When a voltage is applied, the first piezoelectric element 121a may contract or expand in the Z-axis direction. The first piezoelectric element 121a may be a piezoelectric ceramic. The first rod 121b may be coupled to the first piezoelectric element 121a. The first rod 121b may extend in the Z-axis direction. The first rod 121b may move in the Z-axis direction according to the contraction or expansion of the first piezoelectric element 121a. Such movement of the first rod 121b transmits a driving force to the first movable unit 111, making it possible to move the first movable unit 111 and the first lens barrel 1210 in the Z-axis direction.

As an example, the first movable unit 111 may be connected to the rod-shaped first rod 121b elongated in the Z-axis direction. The first piezoelectric element 121a with the first rod 121b arranged at one end may be fixed to the housing 1010 via the first fixing member 121c. One end of the first rod 121b may be connected to the first piezoelectric element 121a, and the other end may be connected to the first movable unit 111. The first piezoelectric element 121a may generate a force that pushes or pulls the first rod 121b in the Z-axis direction. Accordingly, the first movable unit 111, connected to the first rod 121b, and the first lens barrel 1210 fixed to the first movable unit 111, can move in the Z-axis direction.

The second driver 122 may be arranged on one side in the Y-axis direction of the third movable unit 113. The second driver 122 may be connected to the third movable unit 113 and may be configured to provide a driving force to the third movable unit 113. The second driver 122 may be located on one side in the X-axis direction of the third magnet 133. The second driver 122 may be arranged diagonally from the first driver 121 with respect to a reference line parallel to the Z-axis direction.

The structure described for the first driver 121 with reference to FIGS. 3 to 6 may also be applied to the second driver 122. In other words, the second driver 122 may include a second piezoelectric element 122a, a second rod 122b, and a second fixing member 122c. The second driver 122 may be a piezo actuator. When a voltage is applied, the second piezoelectric element 122a may contract or expand in the Z-axis direction. The second piezoelectric element 122a may be a piezoelectric ceramic. The second rod 122b may be coupled to the second piezoelectric element 122a. The second rod 122b may extend in the Z-axis direction. The second rod 122b may move in the Z-axis direction according to the contraction or expansion of the second piezoelectric element 122a. Such movement of the second rod 122b transmits a driving force to the third movable unit 113, making it possible to move the third movable unit 113 and the second lens barrel 1220 in the Z-axis direction.

As an example, the third movable unit 113 may be connected to the rod-shaped second rod 122b elongated in the Z-axis direction. The second piezoelectric element 122a with the second rod 122b arranged at one end may be fixed to the housing 1010 via the second fixing member 122c. One end of the second rod 122b may be connected to the second piezoelectric element 122a, and the other end may be connected to the third movable unit 113. The second piezoelectric element 122a may generate a force that pushes or pulls the second rod 122b in the Z-axis direction. Accordingly, the third movable unit 113, connected to the second rod 122b, and the second lens barrel 1220 fixed to the third movable unit 113, can move in the Z-axis direction.

The yoke 140 may be arranged to face the first magnet 131 in the Y-axis direction. The yoke 140 may be arranged on one side in the Y-axis direction of the first movable unit 111. The first magnet 131 may be arranged between the first movable unit 111 and the yoke 140 along the Y-axis direction. The yoke 140 may be arranged to face the first magnet 131 in the Y-axis direction.

The yoke 140 may be arranged to face the second magnet 132 in the Y-axis direction. The yoke 140 may be arranged on one side in the Y-axis direction of the second movable unit 112. The second magnet 132 may be arranged between the second movable unit 112 and the yoke 140 along the Y-axis direction. The yoke 140 may be arranged to face the second magnet 132 in the Y-axis direction.

The yoke 140 may be arranged to face the third magnet 133 in the Y-axis direction. The yoke 140 may be arranged on one side in the Y-axis direction of the third movable unit 113. The third magnet 133 may be arranged between the third movable unit 113 and the yoke 140 along the Y-axis direction. The yoke 140 may be arranged to face the third magnet 133 in the Y-axis direction.

The yoke 140 may be arranged to face the fourth magnet 134 in the Y-axis direction. The yoke 140 may be arranged on one side in the Y-axis direction of the fourth movable unit 114. The fourth magnet 134 may be arranged between the fourth movable unit 114 and the yoke 140 along the Y-axis direction. The yoke 140 may be arranged to face the fourth magnet 134 in the Y-axis direction.

The yoke 140 may extend in the Z-axis direction. The yoke 140 may extend in the Z-axis direction in order to include a portion overlapping at least one of the first to fourth magnets 131, 132, 133, and 134 in the Y-axis direction.

In FIGS. 2 and 3, the yoke 140 is shown in an expanded plate shape in order to overlap the first to fourth movable units 114 in the Y-axis direction, but is not limited thereto, and regarding the shape of the yoke 140, any shape is possible which extends in the Z-axis direction and can be arranged to face each of the first to fourth movable units 114. For example, a plurality of yokes may be each arranged to face each of the first to fourth movable units 114.

The yoke 140 may be located between the first movable unit 111 and the bottom surface of the housing 1010. The first movable unit 111 may be pressed in a direction (Y-axis direction) toward the bottom surface of the housing 1010 by a magnetic force acting between the yoke 140 and the first magnet 131. Accordingly, the first movable unit 111 can maintain a state of contact with the first driver 121. The first movable unit 111 may be configured to slide on an upper part of the first rod 121b and roll on an upper part of the first rolling member 151.

The first magnet 131 may be arranged between the first movable unit 111 and the housing 1010 along the Y-axis direction. The first magnet 131 may be arranged between the first movable unit 111 and the yoke 140 along the Y-axis direction. The second magnet 132 may be arranged between the second movable unit 112 and the housing 1010 along the Y-axis direction. The second magnet 132 may be arranged between the second movable unit 112 and the yoke 140 along the Y-axis direction.

The yoke 140 may be located between the third movable unit 113 and the bottom surface of the housing 1010. The third movable unit 113 may be pressed in a direction (Y-axis direction) toward the bottom surface of the housing 1010 by a magnetic force acting between the yoke 140 and the third magnet 133. Accordingly, the third movable unit 113 can maintain a state of contact with the second driver 122. The third movable unit 113 may be configured to slide on an upper part of the third rods 121b and 122b and roll on an upper part of the second rolling member 152.

The third magnet 133 may be arranged between the third movable unit 113 and the housing 1010 along the Y-axis direction. The third magnet 133 may be arranged between the third movable unit 113 and the yoke 140 along the Y-axis direction. The fourth magnet 134 may be arranged between the fourth movable unit 114 and the housing 1010 along the Y-axis direction. The fourth magnet 134 may be arranged between the fourth movable unit 114 and the yoke 140 along the Y-axis direction.

Referring to FIG. 4, the housing 1010 may include a first guide groove 1010a in which the first rod 121b is arranged on one side in the Y-axis direction of the first driver 121. The first rod 121b may be seated in the first guide groove 1010a and arranged between the first movable unit 111 and the housing 1010. The first guide groove 1010a may extend in the Z-axis direction. The first guide groove 1010a may have various cross-sectional shapes, such as a round shape, a V-shape, or a polygonal shape.

At least one first rolling member 151 may be arranged on one side in the Y-axis direction of the second movable unit 112. The first rolling member 151 may be arranged in the first guide groove 1010a elongated in the optical axis direction on the bottom surface of the housing 1010. The housing 1010 may have a second guide groove 1010b in which the first rolling member 151 is arranged so that the second movable unit 112 can be driven in the Z-axis direction. The first rolling member 151 may be accommodated in the second guide groove 1010b and arranged between the second movable unit 112 and the housing 1010. The second guide groove 1010b may extend in the Z-axis direction. The second guide groove 1010b may have various cross-sectional shapes, such as a round shape, a V-shape, or a polygonal shape.

A third guide groove 1010c in which the second rod 122b is arranged may be located on one side in the Y-axis direction of the second driver 122. The second rod 122b may be seated in the third guide groove 1010c and arranged between the third movable unit 113 and the housing 1010. The third guide groove 1010c may extend in the Z-axis direction. The third guide groove 1010c may have various cross-sectional shapes, such as a round shape, a V-shape, or a polygonal shape. The third guide groove 1010c may be located diagonally from the first guide groove 1010a with respect to the reference line parallel to the Z-axis direction.

The second rolling member 152 may be arranged on one side in the Y-axis direction of the third movable unit 113. The second rolling member 152 may be arranged in a fourth guide groove 1010d elongated in the optical axis direction on the bottom surface of the housing 1010. The housing 1010 may have the fourth guide groove 1010d in which the second rolling member 152 is arranged so that the fourth movable unit 114 can be driven in the Z-axis direction. The second rolling member 152 may be accommodated in the fourth guide groove 1010d and arranged between the fourth movable unit 114 and the housing 1010. The fourth guide groove 1010d may extend in the Z-axis direction. The fourth guide groove 1010d may have various cross-sectional shapes, such as a round shape, a V-shape, or a polygonal shape.

Referring to FIG. 7, the first magnet 131 and the second magnet 132 may be arranged between the first rod 121b and the first rolling member 151 along the X-axis direction. Referring to FIG. 8, the third magnet 133 and the fourth magnet 134 may be arranged between the second rod and the second rolling member 152 along the X-axis direction.

According to the camera module, according to the above-described embodiment, a contact force between the driver and the movable unit is maintained using an attractive force between the magnet and the yoke. Accordingly, it is possible to provide a miniaturized camera actuator structure that is strong against physical impact, is easy to restore even after deformation due to external impact, and is not affected by external magnetic fields, which is advantageous in maintaining quality. In addition, according to the camera module according to the above-described embodiment, the size of the magnet arranged on one surface of the movable unit connected to the driver is formed to be larger than the magnet arranged on one surface of the movable unit facing the former magnet in the X-axis direction. Accordingly, even when the rolling member is provided in the singular, the desired driving force can be efficiently provided, minimizing the number of components of the camera actuator. Additionally, the magnet is arranged between the rod and the rolling member to prevent tilt from occurring due to non-uniform magnetic force, and the plurality of drivers is arranged in a diagonal direction to move the movable units more stably.

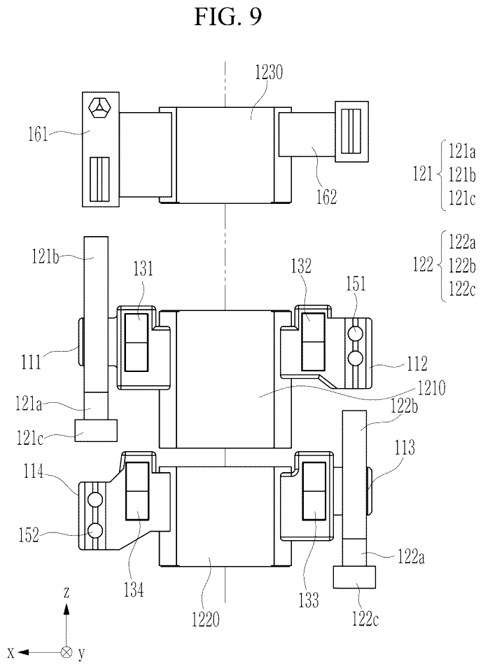

Below, a camera module, according to another embodiment, will be described with reference to FIG. 9.

FIG. 9 is a plan view of a camera actuator according to another embodiment.

FIG. 9 is a plan view of a camera actuator according to another embodiment. Detailed descriptions of the same constituent elements will be omitted. A camera actuator 100 of FIG. 9 may be similar to the camera actuator 100 of FIG. 6, except for the size of the magnet and the number of rolling members.

Referring to FIG. 9, the camera module 1000, according to an embodiment, may include a plurality of first rolling members 151 and a plurality of second rolling members 152 compared to the camera module 1000 according to an embodiment shown in FIGS. 3 to 8, and the sizes of the first to fourth magnets 131, 132, 133, and 134 may be constant. However, the present disclosure is not limited thereto. As in the camera module 1000, according to the above-described embodiment, the sizes of the first to fourth magnets 131, 132, 133, and 134 may be changed in various ways, including a case where the size of the first magnet 131 is larger than the size of the second magnet 132. The size of the third magnet 133 is larger than that of the fourth magnet.

According to the camera module of the other embodiment described above, the manufacturing cost can be reduced by using the plurality of magnets having a constant size, and the binding force can be increased by using the plurality of rolling members. In addition, driving stability can be improved by applying a three-point support structure in which the rod of the driver and the plurality of rolling members are combined.

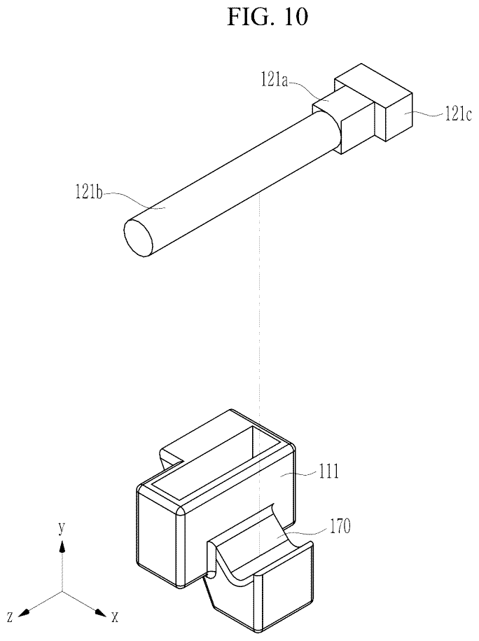

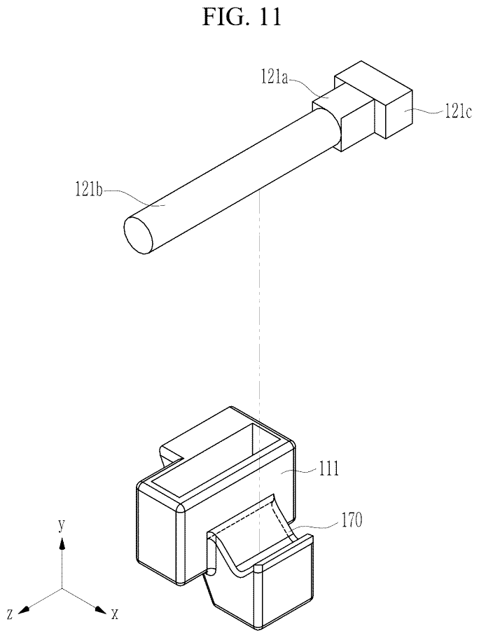

Below, camera modules according to other embodiments will be described with reference to FIGS. 10 and 11.

FIG. 10 is a perspective view of a movable unit and a driver according to still another embodiment, and FIG. 11 is a perspective view of a movable unit and a driver according to a variation of a camera module according to still another embodiment.

Referring to FIGS. 10 and 11, the camera module 1000, according to an embodiment, is similar to the camera module 1000, according to an embodiment described with reference to FIGS. 3 to 8. Detailed descriptions of the same constituent elements will be omitted. The camera actuator 100 of FIGS. 10 and 11 may be similar to the camera actuator 100 of FIGS. 3 to 8, except for the shapes of a friction part 170 and a peripheral part.

In addition, the first movable unit 111 and the first driver 121 will be described below with reference to FIGS. 10 and 11, but this example and the following description can also be applied to the third movable unit 113 and the second driver 122.

Referring to FIG. 10, compared to the camera module 1000 according to the embodiment shown in FIGS. 3 to 8, in the camera module 1000 according to an embodiment, the first driver 121 may further include a friction part 170 arranged on one surface of the first movable unit 111 facing the first rod 121b. The friction part 170 may be configured to have higher wear resistance than the first movable unit 111. As an example, the friction part 170 may be formed of metal. Likewise, although not shown, a friction part 170 may be arranged on one surface of the third movable unit 113 facing the second rod 122b.

Referring to FIG. 11, in the camera module 1000 according to a variation, the friction part 170 may be at least partially embedded in one surface of the first movable unit 111 facing the first rod 121b. The friction part 170 may be formed using an insert injection process together with the first movable unit 111. Likewise, although not shown, the friction part 170 may be at least partially embedded in one surface of the third movable unit 113 facing the second rod 122b.

According to the camera module according to another embodiment described above, it is possible to prevent one surface of the movable unit in contact with the driver from being worn, thereby improving the durability of the camera actuator.

In one or more embodiments of the camera module and the camera actuator, a contact state between a driving body and a movable body is maintained using a force between the piezoelectric element and the yoke. Accordingly, it is possible to provide a miniaturized camera structure that is strong against physical impact, is easy to restore even after deformation due to external impact, and is not affected by external magnetic fields, which is advantageous in maintaining quality.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a housing having an internal space;
a lens module accommodated in the internal space of the housing and comprising a first lens barrel; and
a camera actuator, connected to the first lens barrel, configured to provide a driving force, the camera actuator comprising:
a first movable unit configured to move the first lens barrel in a first direction;
a first driver, comprising a first piezoelectric element, connected to the first movable unit, and configured to provide a driving force to the first movable unit; and
a magnet and a yoke disposed between the first movable unit and the housing in a second direction intersecting with the first direction.

2. The camera module of claim 1, wherein the magnet is disposed on one surface of the first movable unit facing the housing, and
wherein the yoke is disposed to face the magnet in the second direction.

3. The camera module of claim 1, wherein the yoke extends in the first direction to include a portion overlapping the magnet in the second direction.

4. The camera module of claim 1, wherein the camera actuator further comprises:
a second movable unit disposed to face the first movable unit with the first lens barrel interposed therebetween, in a third direction perpendicular to the first direction and the second direction, and
at least one first rolling member disposed on one side of the second movable unit, and
wherein the second movable unit is configured to move the first lens barrel in the first direction using the driving force of the first driver.

5. The camera module of claim 4, wherein the magnet comprises:
a first magnet disposed on one surface of the first movable unit, and
a second magnet disposed on one surface of the second movable unit, and
wherein the first magnet is larger in size than the second magnet.

6. The camera module of claim 5, wherein the first rolling member is a single ball member.

7. The camera module of claim 4, wherein the first driver further comprises:
a rod disposed to connect one end to the first piezoelectric element and another end to the first movable unit, and
wherein the first magnet and the second magnet are disposed between the rod and the first rolling member along the third direction.

8. The camera module of claim 1, wherein the first driver further comprises:
a rod disposed such that one end is connected to the first piezoelectric element and another end is connected to the first movable unit, and
a friction part configured to have higher wear resistance than the first movable unit and disposed on one surface of the first movable unit facing the rod.

9. The camera module of claim 1, wherein the lens module further comprises:
a second lens barrel disposed on one side in the first direction of the first lens barrel and configured to be movable with respect to the housing, and
a third lens barrel disposed on another side in the first direction of the first lens barrel and fixed to the housing.

10. The camera module of claim 9, wherein the camera actuator further comprises:
a third movable unit disposed on one side of the second lens barrel and configured to move the second lens barrel in the first direction,
a fourth movable unit disposed to face the third movable unit with the second lens barrel interposed therebetween, in a third direction perpendicular to the first direction and the second direction, and
a second driver comprising a second piezoelectric element, connected to the third movable unit, and configured to provide a driving force to the third movable unit.

11. The camera module of claim 10, further comprising at least one second rolling member disposed on one side of the fourth movable unit.

12. The camera module of claim 11, wherein the second driver is disposed diagonally from the first driver with respect to a reference line parallel to the first direction.

13. The camera module of claim 1, further comprising a reflection module, disposed in front of the first lens barrel in the first direction, configured to change a path of incident light.

14. A camera actuator comprising:
a first movable unit configured to move along a first direction;
a driver, comprising a piezoelectric element, connected to the first movable unit, and configured to provide a driving force to the first movable unit;
a yoke disposed on one side of the first movable unit in a second direction intersecting with the first direction; and
a magnet disposed between the first movable unit and the yoke in the second direction.

15. The camera actuator of claim 14, wherein the yoke is disposed to face the magnet in the second direction.

16. The camera actuator of claim 14, wherein the yoke extends in the first direction to include a portion overlapping the magnet in the second direction.

17. The camera actuator of claim 14, wherein the driver is disposed on one side in the second direction of the first movable unit, and
wherein the camera actuator further comprises:
a second movable unit disposed to face the first movable unit in a third direction perpendicular to the first direction and the second direction, and
at least one rolling member disposed on one side of the second movable unit.

18. The camera actuator of claim 17, wherein the magnet comprises:
a first magnet disposed on one surface of the first movable unit, and
a second magnet disposed on one surface of the second movable unit, and
wherein the first magnet is larger in size than the second magnet.

19. The camera actuator of claim 18, wherein the driver further comprises a rod disposed such that one end is connected to the piezoelectric element and another end is connected to the first movable unit, and
wherein the first magnet and the second magnet are disposed between the rod and the first rolling member along the third direction.

20. The camera actuator of claim 19, wherein the driver further comprises a friction part configured to have higher wear resistance than the first movable unit and disposed on one surface of the first movable unit facing the rod.
